(19) United States
(12) Patent Application Publication
(10) Pub. No.: US 2007/0255799 A1
(43) Pub. Date: Nov. 1, 2007

(54) Method of discovering and accessing web pages

(75) Inventor: Stephen K. Forbes, Raleigh, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/412,366

(22) Filed: Apr. 27, 2006

(51) Int. Cl. G06F 15/16

(52) U.S. Cl. 709/217

(57) ABSTRACT

A communication terminal accesses a web page for a target entity using the telephone number of the target entity. The communication terminal directs a web access information request to a web access information server maintained by the target entity using a telephone number entered by the user or retrieved from memory. The information server returns web access information in response to the web access information request. The communication terminal can then use the returned web access information to access the target entity's web page.

### BACKGROUND

The present invention relates to a method of locating and accessing web pages without prior knowledge of the web page address.

One of the primary uses of the Internet today is to obtain information about products and services offered by businesses. Often, users are interested in goods and services from local businesses. Information about a specific store or location is often hard to find. For example, a person may want to locate information about a local franchisee for a national chain. Typically, the user must access the website for the national chain then navigate through the website to locate information about a local store.

Another difficulty in acquiring information about goods or services of local businesses is obtaining a uniform resource locator (URL) for the business. The user may not know the URL of a business for which information is sought. The user may, however, have a telephone number for the business. It would be a convenience for consumers to be able to access the web page for a business using the telephone number of the business.

### SUMMARY

The present invention relates to a method of locating and accessing a web page without prior knowledge of the uniform resource locator (URL) or IP address for the web page. In one exemplary embodiment, the user enters a phone number for a business or other target entity and selects a browsing function instead of a normal voice communication function. In response to the selection of the browsing function, the mobile station sends a web access information request message to the web page owner. In reply to the web access information request, the web page owner sends the requesting party a URL response message containing the URL or IP address for one or more web pages. The URL response message may include a brief description of each web page identified. If only one web page is returned, the requesting mobile terminal may automatically connect to the identified web page without further input from the user. Alternatively, the mobile station may display web page information to the user and wait for user confirmation before connecting to the web page. If more than one web page is returned, the mobile terminal may display a list of web pages on a display. After the user selects a web page, the mobile terminal uses the corresponding URL or IP address to connect to the selected web page.

### BRIEF DESCRIPTION OF THE DRAWINGS

FIG. 1 illustrates an exemplary communication network.

FIG. 2 illustrates an exemplary procedure for accessing web pages.

FIG. 3 illustrates an exemplary communication terminal for accessing web pages.

### DETAILED DESCRIPTION

The present invention relates to a method of locating and accessing a web page without prior knowledge of the uniform resource locator (URL) or IP address for the web page. The present invention is particularly useful for mobile communications terminals such as cellular phones, PDAs, and laptop computers, but may be implemented in fixed communication terminals as well.

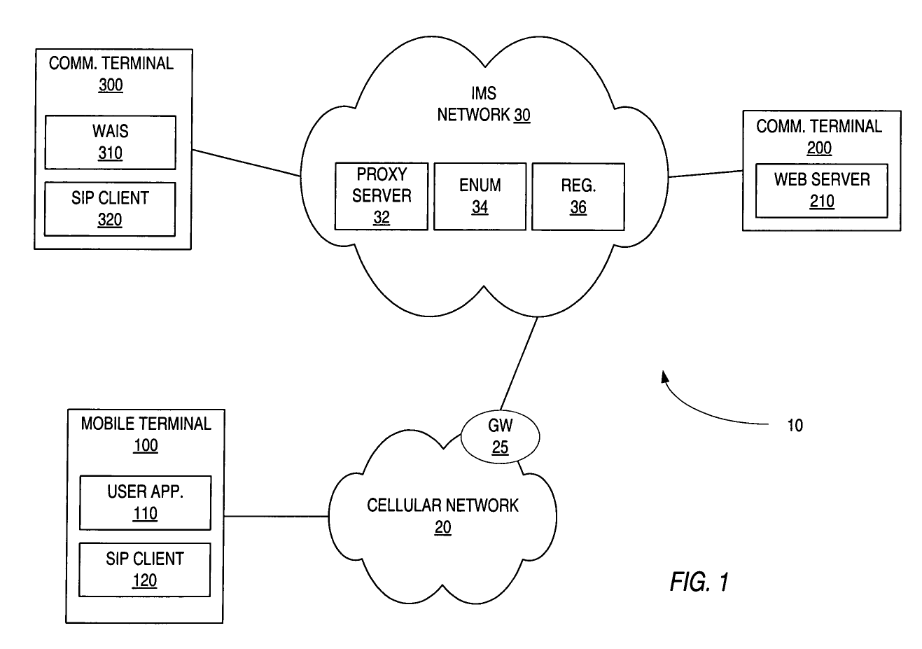

Referring to FIG. 1, the present invention will be described in the context of an exemplary communication network 10. It should be understood, however, that the network architecture is not material to the present invention. The exemplary communication network 10 comprises a packet-switched cellular network 20 and an IP network 30 interconnected with the cellular network 20 via gateway 25. Cellular network 20 may use any known access technology such as GSM, GPRS, EDGE, cdmaOne, cdma2000, WCDMS, or UMTS network. IP network 30 may comprise, for example, an IP Multimedia Subsystem (IMS) network or a global network such as the Internet.

A mobile terminal 100 connects to the cellular network 20. The mobile terminal 100 may comprise, for example, a cellular telephone, personal digital assistant (PDA), laptop computer, other mobile communication device. Communication terminals 200 and 300 connect to the IP network 30. In this particular example, communication terminals 200 and 300 are fixed terminals, such as computers. Those skilled in the art will appreciate, however, that terminals 200 and 300 could also be mobile terminals. A web server 210 resides in the communication terminal 200. In the following discussion, it is assumed that the web server 210 hosts a web page for a business or other target entity associated with a particular telephone number. A web access information server (WAIS) 310 maintained by the target entity resides in communication terminal 300. Web access information server 310 communicates with mobile terminal 100 to provide the mobile terminal 100 with information necessary to access the web pages hosted by web server 210. While shown residing in separate host devices, those skilled in the art will appreciate that web server 210 and web access information server 310 may reside in the same host device.

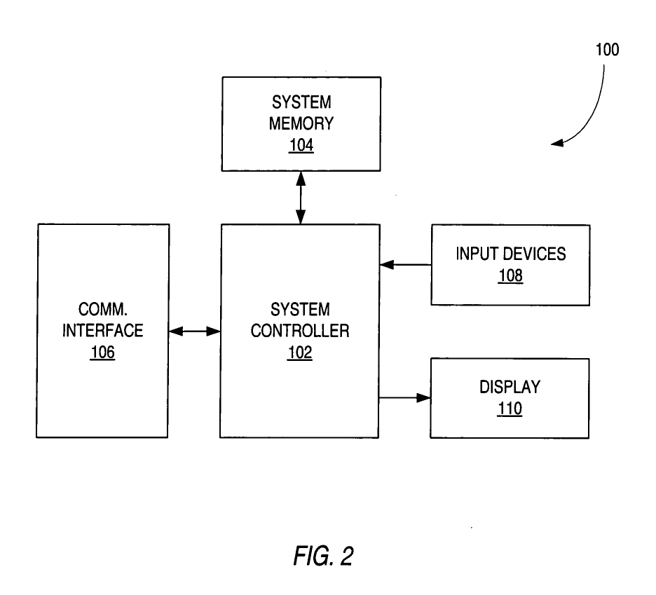

FIG. 2 is a block diagram of an exemplary mobile terminal 100, which may comprise a cellular telephone, a satellite telephone, a personal digital assistant (PDAs), lap-top computer, or the like. Mobile terminal 100 includes a system controller 102 to control overall operation of the communication device 10, system memory 104 to store programs and data needed for operation, a communication interface 106 for communicating with remote devices, input devices 108 for receiving user input, and a display 110 to display information for viewing by the user. Communication terminals 200 and 300 may have the same components as mobile terminal 100.

The present invention provides a method enabling a user application 110 residing in the mobile terminal 100 or other communication terminal 200, 300 to locate and access a web page for a target entity being hosted on the web server 210 using only the telephone number of the associated business or target entity. The user application 110 in mobile terminal 100 communicates with the web access information server 310 using, for example, the Session Initiation Protocol (SIP). SIP is an end-to-end signaling protocol for establishing, maintaining and terminating communication sessions between end devices. SIP has also been extended for instant messaging and presence services. Those skilled in the art will recognize that other protocols could also be used, but SIP is used herein as an example due to its widespread adoption and use.

A SIP client 120 interfacing with the user application 110 in mobile terminal 100 functions as a SIP user agent and provides signaling services to the user application 110. SIP client 120 may be a separate application in the mobile terminal 100. Alternatively, the functionality of the SIP client 120 could be integrated into the user application. Also, those skilled in the art will appreciate that additional software components may exist between the user application 110 and the SIP client, so that the user application 110 need not communicate directly with the SIP client 120. For example, an IMS service layer providing IMS services could be disposed logically between the SIP client 120 and the user application 100. Similarly, a SIP client 320 interfacing with the web access information server 310 in a communication terminal 300 functions as a SIP user agent and provides signaling services to the web access information server 310. Because both mobile terminal 100 and web access information server 310 are SIP-compliant, the user application 110 in mobile terminal 100 can communicate with the web access information server 310. As noted above in connection with the mobile terminal 100, the functionality of the SIP client 320 and web access information server 310 could be integrated in a single application running on communication device 300.

IP network 30 includes several SIP network components. These components include one or more SIP proxy servers 32, an ENUM database 34, and a SIP registrar 36. The SIP proxy servers 32 function as forwarding devices that receive SIP messages and forward the SIP messages towards the final destination. Proxy servers 32 can also provide functions such as authentication and authorization. The SIP registrar 36 is a network component that receives SIP registrations from users and maintains information about their current location. The ENUM database 34 is a database that maps E.1 64 telephone numbers into routable IP addresses. The function of these elements in the context of the present invention is described below.

In use, the user of mobile terminal 100 accesses the web page for a business or entity by entering the telephone number of the business or entity and selecting a browsing function. The browsing function can be selected, for example, by pressing a BROWSE key on the mobile terminal 100. Alternatively, the telephone number may be selected from an address book, or the SIP URI of the target entity can be entered. The telephone number entered may be the same number used for voice communications. Thus, the same telephone number can be used for both voice communications and for accessing a web page for a business. When the user selects the browsing function, the user application 110 in mobile terminal 100 establishes communication with the web access information server 310 and requests web access information. Web access information server 310 may return web access information for one or more web pages or pages. The returned web access information could include the current IP address of the web server to allow the possibility of hosting the web server on a mobile terminal. For example, if the business is a local franchise, the web access information returned may include a uniform resource locator (URL) and/or IP address for the local franchisee's web page along with a separate URL and/or IP address for the franchisor's web page. The web access information may further include a title or brief description of each web page returned. If web access information for a single web page is returned, mobile terminal 100 may automatically connect to the identified web page without further input from the user. Alternatively, the mobile terminal 100 may display web page information to the user and wait for user confirmation before connecting to the web page. If access information for more than one web page is returned, the mobile terminal 100 may display a list of web pages on display 110. The displayed information may comprise the domain name, title, and/or description of the webpage. After the user selects a web page, mobile terminal 100 connects to the selected web page in conventional fashion. If the web access information comprises a URL, the mobile terminal 100 may contact a domain name server (DNS) to get a corresponding IP address for the web page. If the web access information includes the IP address, it can be used to directly access the web page without the necessity of performing a DNS lookup.

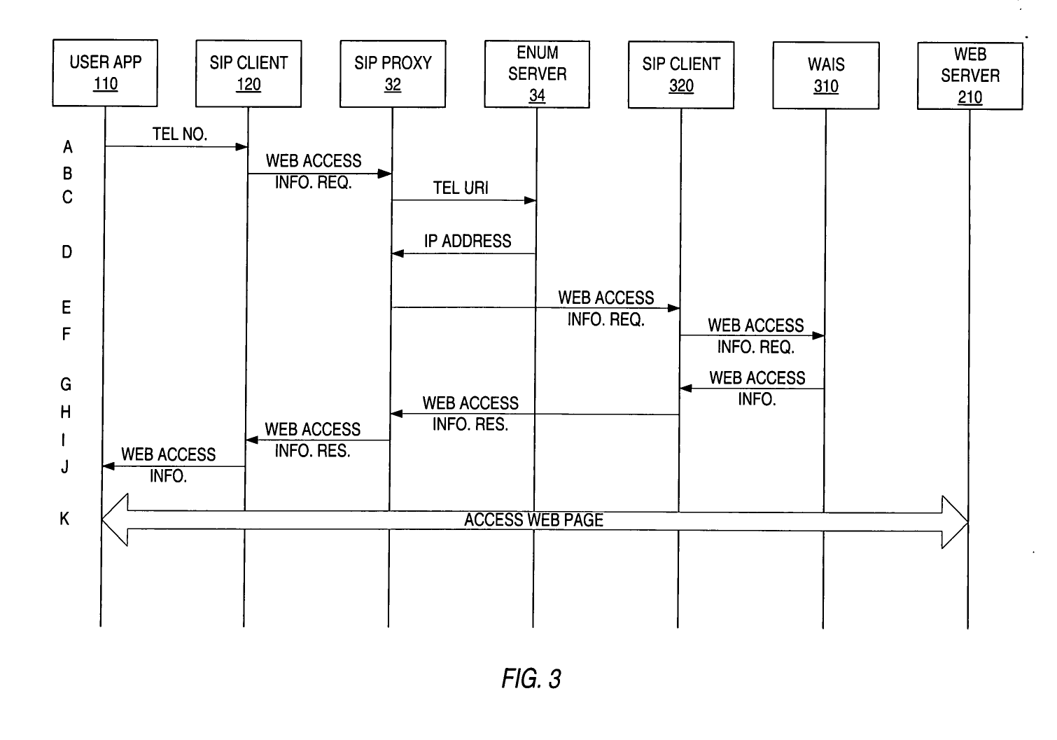

FIG. 3 illustrates an exemplary procedure for locating and accessing a web page using a mobile terminal 100. The same procedure may also be implemented in a fixed communication terminal. A user application 110 residing in mobile terminal 100 provides the SIP client with the telephone number entered by the user (Step A). The SIP client in turn generates a web access information request message and sends the web access information request message to a SIP proxy server 32 (Step B). As will be described in greater detail below, the web access information request may comprise a standard SIP request message, such as a SIP MESSAGE request. Alternatively, the web access information request could comprise a newly defined type of SIP request. This latter approach would require modification of the existing standards.

In generating the web access information request, the SIP client formats the telephone number as a telephone uniform resource indicator (tel URI). A URI identifies a particular communication resource, which in this example is the WAIS 310. When the proxy server 32 receives the web access information request, the proxy server 32 converts the tel URI to an IP address using well known procedures. One exemplary procedure is described in the Request For Comments (RFC) 3271 published by the Internet Engineering Task Force (IETF). RFC 3271 describes a procedure for converting fully qualified E.164 telephone numbers in to IP addresses. SIP proxy server 32 sends the tel URI to an ENUM server 34 (Step C), which returns the corresponding IP address (Step D). The SIP proxy server 32 reformats the web access information request, replacing the tel URI in the SIP request with the IP address received from the ENUM server and forwards the web access information request to the web access information server 310 (Step E).

The web access information request is received by the SIP client 320 for the web access information server 310. Upon receipt of the web access information request, the SIP client 320 passes the request to the web access information server 310 (Step F). In response, web access information server 310 provides web access information to the SIP client 320 (Step G). SIP client 320 generates a web access information response message and sends the web access information response message to the SIP proxy server 32 (Step H). SIP proxy server 32 forwards the web access information response message to SIP client 120 (Step I). The SIP client 120 then passes the web access information to the user application 110 (Step J), which may use the access information to access a web page as previously described (Step K).

As noted above, the web access information request may conveniently comprise a standard SIP request message using the MESSAGE method. When the MESSAGE method is used, the web access information request comprises a SIP MESSAGE request which contains an indication that web access information is being requested. The indication may be included in a header field or in the message body. For example, a newly-defined content type may be used to indicate that the SIP MESSAGE request is a web access information request message. In this case, the SIP MESSAGE request would not include a message body. Alternatively, a predetermined message may be inserted into the message body to indicate that the SIP MESSAGE request is a web access information request. For example, the text “URL REQUEST” can be inserted into the message body to indicate a request for web access information. The web access information response may also use the MESSAGE method to return web access information. For example, the web access information can be inserted into the message body of a SIP MESSAGE response. The web access information could be formatted, for example, as a delimited text file or as an XML document. Other data formats could also be used.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of acquiring web access information for accessing a web page implemented by an access terminal, said method comprising:
directing a request for web access information to a web access information server maintained by a target entity using a telephone number for the target entity; and
receiving web access information for accessing a web page of the target entity from the web access information server in response to the request.

2. The method of claim 1 further comprising accessing a web page using said web access information received from said target entity in response to said web access information request.

3. The method of claim 1 wherein said web access information includes information for accessing multiple web pages.

4. The method of claim 3 further comprising:
displaying a list of web pages identified by said web access information on a display;
receiving a user selection of one of said web pages; and
accessing the selected web page.

5. The method of claim 1 wherein directing a request for web access information to a web access information server maintained by a target entity comprises:
generating a web access information request;
addressing said web access information request using the telephone number of said target entity; and
sending the web access information request to said target entity.

6. The method of claim 5 wherein generating a web access information request comprises generating a SIP request message containing an indication that web access information is being requested.

7. The method of claim 6 wherein said SIP request message comprises a SIP MESSAGE request.

8. The method of claim 7 wherein said indication comprises a predefined content type in a header field of said SIP MESSAGE request.

9. The method of claim 7 wherein said indication comprises a predefined message in a message body of said SIP MESSAGE request.

10. The method of claim 6 wherein addressing said web access information request using the telephone number of said target entity comprises formatting said telephone number as a uniform resource indicator and inserting the uniform resource indicator in an address field of said SIP request message.

11. A communication terminal comprising:
a communications interface for communicating with remote devices over a communication network; and
a control unit operatively connected to said communications interface, said control unit including a control processor configured to:
direct a request for web access information to a web access information server maintained by a target entity using a telephone number for the target entity; and
receive web access information for accessing a web page of the target entity from the web access information server in response to the request.

12. The communication terminal of claim 11 wherein the control processor is further configured to access a web page using said web access information received from said target entity in response to said web access information request.

13. The communication terminal of claim 11 wherein said web access information includes information for accessing multiple web pages.

14. The communication terminal of claim 13 wherein the control processor is further configured to:
display a list of web pages identified by said web access information on a display;
receive a user selection of one of said web pages; and
access the selected web page.

15. The communication terminal of claim 11 wherein the control processor directs a request for web access information to a web access information server maintained by a target entity by:
generating a web access information request;
addressing said web access information request using the telephone number of said target entity; and
sending the web access information request to said target entity.

16. The communication terminal of claim 15 wherein the control processor generates a web access information request by generating a SIP request message containing an indication that web access information is being requested.

17. The communication terminal of claim 16 wherein said SIP request message comprises a SIP MESSAGE request.

18. The communication terminal of claim 17 wherein said indication comprises a predefined content type in a header field of said SIP MESSAGE request.

19. The communication terminal of claim 17 wherein said indication comprises a predefined message in a message body of said SIP MESSAGE request.

20. The communication terminal of claim 16 wherein the control processor addresses said web access information request using the telephone number of said target entity by formatting said telephone number as a uniform resource indicator and inserting the uniform resource indicator in an address field of said SIP request message.

21. A communication system comprising:
a web server hosting a web page associated with a target entity;
a web access information server maintained by said target entity for providing web access information for accessing said web page; and
a communication terminal comprising a processor configured to:
generate a web access information request including a telephone number for the target entity entered or selected by a user;
transmit said web access information request to said web access information server;
receive web access information responsive to said request; and
access said web page for said target entity using said web access information provided by said web access information server.

22. The communication system of claim 21 wherein said web access information includes information for accessing multiple web pages.

23. The communication system of claim 22 wherein the communication terminal is further configured to:
display a list of web pages identified by said web access information on a display;
receive a user selection of one of said web pages; and
access the selected web page.

24. The communication system of claim 21 wherein the web access information request generated by said communication terminal comprises a SIP request message.

25. The communication system of claim 24 wherein the SIP request message contains an indication that web access information is being requested.

26. The communication system of claim 25 wherein said SIP request message comprises a SIP MESSAGE request.

27. The communication system of claim 26 wherein said indication comprises a predefined content type in a header field of said SIP MESSAGE request.

28. The communication system of claim 26 wherein said indication comprises a predefined message in a message body of said SIP MESSAGE request.
